(19) United States
(12) Patent Application Publication
(10) Pub. No.: US 2021/0387833 A1
(43) Pub. Date: Dec. 16, 2021

(54) ARRANGEMENT FOR CONTROLLING A ROTATOR BY IMAGE SENSING MEANS

(71) Applicant: Indexator Rotator Systems AB, Vindeln (SE)

(72) Inventor: Joakim Harr, Vindeln (SE)

(73) Assignee: Indexator Rotator Systems AB, Vindeln (SE)

(21) Appl. No.: 17/281,639

(22) PCT Filed: Sep. 24, 2019
(86) PCT No.: PCT/SE2019/050908

§ 371 Date: Mar. 31, 2021

(30) Foreign Application Priority Data
Oct. 12, 2018 (SE) 1851247-5

(51) Int. Cl. B66C 13/46; B66C 13/08; B66C 1/68

(52) U.S. Cl. CPC B66C 13/46; B66C 2700/0371; B66C 1/68; B66C 13/085

(57) ABSTRACT

The invention relates to an arrangement (600) for controlling a rotator, the arrangement (600) comprising a control device (100); a rotator (200) for a jib-carried tool (300); and one or more image sensing devices (700); wherein the control device (100) is configured to obtain one or more signals (702) from the one or more image sensing devices (700), obtain a location of a target object (500) based on the one or more signals (702), and control the rotator (200) based on the location of the target object (500). Furthermore, the invention also relates to a corresponding method, a vehicle comprising such an arrangement and a computer program.

### TECHNICAL FIELD

The invention relates to an arrangement for controlling a rotator. Furthermore, the invention also relates to a corresponding method, a vehicle comprising such an arrangement and a computer program.

### BACKGROUND

A forwarder is a type of forestry vehicle used for carrying logs from stump to roadside landing. The forwarder carries logs clear of ground and are often used in conjunction with tree harvesters in so called cut-to-length operations. Forwarders are commonly categorized on their load carrying capabilities.

For lifting logs the forwarder is often equipped with a crane system which is connected to a jib-carried tool in the form of a grapple. The crane system often comprises two or three crane arm parts connected to each other by crane arm joints. In between a crane arm tip and the tool, a so-called rotator is often arranged so that the tool can be rotated in respect to the crane arm tip. With the rotator loading and unloading is substantially simplified.

Rotators comes in a number of different types and the most common are electric and hydraulic rotators. That means that the first type is electrically powered whilst the latter type is powered by hydraulic fluid. Rotators are used all over the world besides in forestry, such as in general cargo handling and material handling in ports and scrap yards.

### SUMMARY

An objective of embodiments of the invention is to provide a solution which mitigates or solves the drawbacks and problems of conventional solutions.

A further objective of embodiments of the invention is to provide improved control of rotators compared to conventional solutions.

The above and further objectives are solved by the subject matter of the independent claims. Further advantageous embodiments of the invention can be found in the dependent claims.

According to a first aspect of the invention, the above mentioned and other objectives are achieved with an arrangement for controlling a rotator, the arrangement comprising

a control device;

a rotator for a jib-carried tool; and

one or more image sensing devices;

wherein the control device is configured to
obtain one or more signals from the one or more image sensing devices,
obtain a location of a target object based on the one or more signals, and
control the rotator based on the location of the target object.

An advantage of the arrangement according to the first aspect is improved control of the rotator compared to conventional solutions. Hence, also improved semi-automatic or fully automatic control of the rotator is possible. With semi-automatic or fully automatic control operational tasks can be performed faster and with higher precision which also means higher security.

In an implementation form of an arrangement according to the first aspect, the control device is configured to
obtain a position of rotation between a rotor and a stator of the rotator, and
control the rotator based on the location of the target object and the position of rotation between the rotor and the stator.

By using the position of rotation between a rotor and a stator of the rotator improved control of the rotator is possible.

In an implementation form of an arrangement according to the first aspect, the control device is configured to
obtain the position of rotation between the rotor and the stator of the rotator from an angle meter arranged at the rotator.

In an implementation form of an arrangement according to the first aspect, controlling the rotator comprises
control the position between the rotor and the stator of the rotator in relation to the target object.

In an implementation form of an arrangement according to the first aspect, controlling the rotator comprises
control a speed of change of the position between the rotor and the stator of the rotator.

In an implementation form of an arrangement according to the first aspect, the target object has an elongated form substantially extending in a first direction, and wherein the control device is configured to
obtain the first direction based on the one or more signals,
control the position between the rotor and the stator of the rotator so that the rotator and/or the jib-carried tool is aligned with the first direction.

In an implementation form of an arrangement according to the first aspect, the control device is configured to
obtain an angle δ defining the angle between the rotator or the jib-carried tool and the first direction,
control the position between the rotor and the stator of the rotator so that the rotator and/or the jib-carried tool is aligned with the first direction based on the angle δ.

In an implementation form of an arrangement according to the first aspect, obtaining the angle δ comprises
obtain an angle α defining the angle between the rotator or the jib-carried tool and a crane arm to which the rotator is attached,
obtain an angle ω defining the angle between the crane arm and the first direction, and
obtain the angle δ as a difference between the angle α and the angle ω.

This implementation form relates to the case when the image sensing device is arranged at the rotator above the plane. The angle δ can be defined as δ=α−ω.

In an implementation form of an arrangement according to the first aspect, the arrangement further comprises a crane arm to which the rotator is attached, and wherein the control device is configured to
control the crane arm based on the location of the target object.

This implementation form means improved control of the crane arm. Further, the arrangement according to the first aspect also makes it possible to provide semiautomatic or fully automatic control of the crane arm.

In an implementation form of an arrangement according to the first aspect, controlling the crane arm comprises
control the crane arm so that the rotator or the jib-carried tool is moving towards the location of the target object.

In an implementation form of an arrangement according to the first aspect, controlling the crane arm comprises
control the crane arm so that the rotator and/or the jib-carried tool is located above the target object.

In an implementation form of an arrangement according to the first aspect, the control device is configured to
obtain a middle point of the target object, and
control the crane arm so that the rotator and/or the jib-carried tool is substantially located above the middle point of the target object.

This implementation form relates to target objects having symmetric or almost symmetric mass distribution, such as pipes.

In an implementation form of an arrangement according to the first aspect, the control device is configured to
obtain a location of a mass centre of the target object, and
control the crane arm so that the rotator and/or the jib-carried tool is located above the mass centre of the target object.

This implementation form relates to target objects having asymmetric or almost asymmetric mass distribution, such as logs.

In an implementation form of an arrangement according to the first aspect, the control device is configured to
obtain position data for the target object and
control the rotator and/or the crane arm based on the position data.

According to this implementation form of a control device can control the rotator, the crane arm or the rotator and the crane arm. The position data can be given as position data relative to the location of the rotator and/or the crane arm. The position data can also be given in absolute coordinates, e.g. according to given standards such as GPS.

In an implementation form of an arrangement according to the first aspect, the control device is configured to
obtain a location of the rotator, and
control the rotator based on the location of the target object and location of the rotator.

In this respect also further parameters such as the position of rotation between the rotor and the stator and above stated angles can be used for controlling the rotator.

This implementation form is especially advantages when the rotator is moving relative to the target object and e.g. is to be aligned with the first direction.

In an implementation form of an arrangement according to the first aspect, at least one of the one or more image sensing devices is arranged at a tip of a crane arm adjacent to the rotator.

In an implementation form of an arrangement according to the first aspect, at least one of the one or more image sensing devices is arranged at the rotator above a plane perpendicular to the rotational axis of the rotator and in which the rotor and the stator are arranged to move relative to each other.

In an implementation form of an arrangement according to the first aspect, at least one of the one or more image sensing devices is arranged at the rotator below a plane perpendicular to the rotational axis of the rotator and in which the rotor and the stator are arranged to move relative to each other.

With plural image sensing devices 3D images can be generated. Further, higher accuracy of the location of the target object is also possible with the use of plural image sensing devices.

In an implementation form of an arrangement according to the first aspect, an image capturing direction of at least one of the one or more image sensing devices is substantially aligned with or in parallel to the rotational axis of the rotator.

In an implementation form of an arrangement according to the first aspect, the image capturing direction is in a direction from the rotator towards the jib-carried tool.

In an implementation form of an arrangement according to the first aspect, the arrangement also comprises a jib-carried tool.

According to a second aspect of the invention, the above mentioned and other objectives are achieved with a vehicle comprising an arrangement according to the first aspect. Non-limiting examples of such a vehicle is a forwarder, a tree harvester and an excavator.

According to a third aspect of the invention, the above mentioned and other objectives are achieved with a method for controlling a rotator, the method comprises
obtaining one or more signals from one or more image sensing devices,
obtaining a location of a target object based on the one or more signals, and
controlling the rotator based on the location of the target object.

The method according to the third aspect can be extended into implementation forms corresponding to the implementation forms of the arrangement according to the first aspect. Hence, an implementation form of the method comprises the feature(s) of the corresponding implementation form of the arrangement.

The advantages of the methods according to the third aspect are the same as those for the corresponding implementation forms of the arrangement according to the first aspect.

The invention also relates to a computer program, characterized in program code, which when run by at least one processor causes said at least one processor to execute any method according to embodiments of the invention. Further, the invention also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the embodiments of the invention will be apparent from the following detailed description.

### BRIEF DESCRIPTION OF THE DRAWINGS

The appended drawings are intended to clarify and explain different embodiments of the invention, in which:

FIG. 1 shows a control device of an arrangement according to an embodiment of the invention;

FIG. 2 shows an arrangement according to an embodiment of the invention;

FIG. 3 shows a method for a control device according to an embodiment of the invention;

FIG. 4 shows an arrangement according to an embodiment of the invention;

FIG. 5 shows an arrangement according to an embodiment of the invention;

FIG. 6 shows an arrangement according to an embodiment of the invention;

FIG. 7 shows an arrangement according to an embodiment of the invention;

FIG. 8 illustrates aligning the rotator and/or the jib-carried tool to a target object according to an embodiment of the invention;

FIG. 9 illustrates aligning the rotator and/or the jib-carried tool to a target object according to an embodiment of the invention; and

FIG. 10 illustrates aligning the rotator and/or the jib-carried tool to a target object according to an embodiment of the invention.

### DETAILED DESCRIPTION

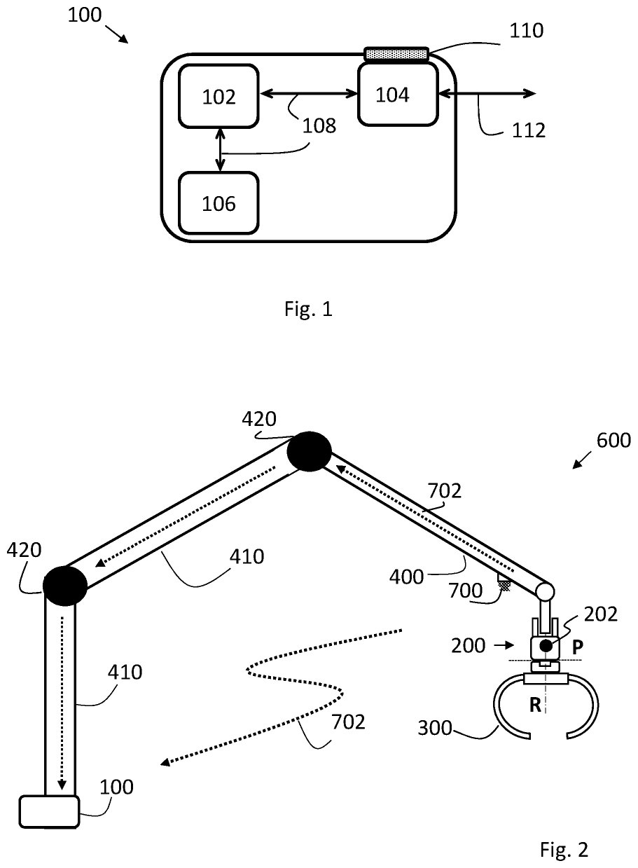

FIG. 1 shows a control device 100 of an arrangement according to an embodiment of the invention. In the embodiment shown in FIG. 1, the client device 100 comprises a processor 102, a transceiver 104 and a memory 106. The processor 102 is coupled to the transceiver 104 and the memory 106 by communication means 108 known in the art. The control device 100 further comprises an antenna or antenna array 110 and/or a wired communication interface 112 coupled to the transceiver 104, which means that the client device 100 is configured for wireless and/or wired communications according to suitable communication standards in the art. That the control device 100 is configured to perform certain actions can in this disclosure be understood to mean that the control device 100 comprises suitable means, such as e.g. the processor 102 and the transceiver 104, configured to perform said actions.

The control device 100 can be a standalone device or part of another device, such as part of a rotator control system, a crane control system or a vehicle control system. Especially, according to embodiments the control device 100 is comprised in an arrangement for controlling a rotator.

FIG. 2 shows such an arrangement 600 according to embodiments of the invention. The arrangement 600 comprises a control device 100. The arrangement further comprises a rotator 200 for a jib-carried tool 300. The rotator 200 is attached to a crane arm 400. The arrangement 600 also comprises one or more image sensing devices 700 which are arranged at the tip of the crane arm 400 and/or at the rotator 200. The control device 100 herein is configured to obtain one or more signals 702 from the one or more image sensing devices 700, obtain a location of a target object 500 based on the one or more signals 702, and control the rotator 200 based on the location of the target object 500.

The one or more signals 702 can be an image sensing signal registered by the image sensing device 700 and transferred/transmitted to the control device 100. The communication between the control device 100 and the image sensing devices 700 can be performed in a number of different ways by using known communication techniques. Two main communication methods are wireless and wired communication technologies. These two different communication technologies can also be combined herein. The specific communication protocols and interfaces used for mentioned communication are outside of the scope of the present disclosure.

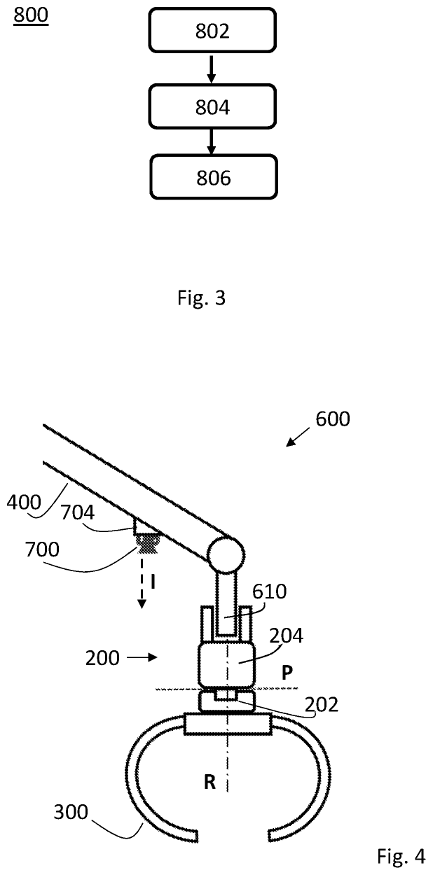

Both communication methods are illustrated in FIG. 3 with the dotted arrows marked with the signals 702. The wired communication signal propagates though a wired signal line which in this non-limiting example is arranged along the crane arm. Obviously, the wireless communication signal propagates through the air from the image sensing device 700 to the control device 100 as also illustrated in FIG. 3.

Further, the location of the target object 500 can be given in suitable format. In one example, the location is given in relation to the location of the rotator 200. In another example the location is given as an absolute position e.g. in a standardized coordination system.

FIG. 3 shows a flow chart of a corresponding method 800 which may be executed in a control device 100, such as the one shown in FIG. 1. The method 800 comprises: obtaining 802 one or more signals 702 from one or more image sensing devices 700, obtaining 804 a location of a target object 500 based on the one or more signals 702, and controlling 806 the rotator 200 based on the location of the target object 500. The method according to the invention can be implemented in a software configured to run in a processor, such as the processor 102 shown in FIG. 1. Hence, the control device 100 can only comprise a processor configured to execute methods of the invention.

There exist different types of rotators in the art, such as electric and hydraulic rotators. The invention herein is not limited to specific types of rotators and therefore the control device 100 can control any types of rotators within the scope of the appended claims.

In an embodiment of the invention, controlling the rotator 200 comprises controlling the position between the rotor 202 and the stator 204 of the rotator 200 in relation to the target object 500. The position of rotation between the rotor 202 and the stator 204 can be given by certain dedicated devices. Such a device gives the rotational relationship between the rotor 202 and stator 204, i.e. how much the rotor 202 is rotated in relation to the stator 204, or vice versa. The rotational relationship can e.g. be given in percentage or in angle, e.g. in degrees or radians where 360 degrees corresponds to a full revolution. In embodiments the control device 100 is configured to obtain the position of rotation between the rotor 202 and the stator 204 of the rotator 200 from an angle meter 202 arranged in the rotator 200 illustrated with the black dot in FIG. 3.

Furthermore, also the speed of change of the position between the rotor 202 and the stator 204 of the rotator 200 can be controlled by the control device 100 according to embodiments of the invention. Thereby, both the position between the rotor 202 and the stator 204 and the speed of this change can be controlled. This means that the control of the rotator 200 can be even better adapted to different applications of the tool 300.

The image sensing devices 700 herein are configured to capture and provide image(s) of the target object. The images are processed so that the location of the target object is obtained. In this respect image processing methods and algorithms known in the art can be used and executed in a processor(s). The processor can be a dedicated image processing processor or a general processor which also performs other processing. The function of the image processing is to obtain/derive the location of the target object based on the images captured by the image sensing devices 700. For this image recognition can be needed for identifying the target object, e.g. a log or a pipe. By recognising surface structure and shape target objects can be recognised. In this respect machine learning algorithm can also be employed to improve the recognition of target objects. Further, by using the identified shape the mass centre of the target object can be computed for asymmetrically shaped target objects, such as logs. However, also weight information can be needed for computing the mass centre. For symmetrically targets objects the middle point of the targets object can directly be derived from the shape.

According to embodiments of the invention, the crane arm 400 herein can be connected to one or more other crane arms 410 with crane joints 420 so as to form a crane system shown in FIG. 3. The crane system comprising one or more crane parts can be controlled by hydraulic means. Non-hydraulic crane systems can also be used in conjunction with the invention.

Furthermore, a jib-carried tool 300 in the form of a grapple is also shown in FIG. 3. The grapple is a non-limiting example of a tool and other examples of jib-carried tools that may be comprised in the present arrangement is a harvester for harvesting trees.

Moreover, FIG. 3 also illustrates a rotational axis R of the rotator 200. Hence, the rotor 202 or the stator 204, depending on the specific configuration, is arranged to rotate around said rotational axis R. The rotation is achieved in that the rotor 202 and stator 204 move relative to each other in or in parallel to an imaginary plane P which is also illustrated in FIG. 3. The plane P is substantially perpendicular to the rotational axis R.

FIG. 4 shows an embodiment of the arrangement 600 when at least one of the image sensing devices 700 is arranged on the tip of the crane arm 400 as also is the case for the embodiment shown in FIG. 3. The part of the crane arm 400 which is closest to the rotator 200 is denoted as the tip of the crane arm 400 as shown in FIG. 4. The tip of the crane arm 400 is the part of the crane arm 400 that is arranged most adjacent to the rotator 200.

In an embodiment of the invention, at least one of the image sensing devices 700 is arranged on the tip of the crane arm 400 by means of an adjustment device 704 located between the image sensing device 700 and the crane arm as shown in FIG. 4. The adjustment device 704 is arranged to hold the image sensing device 700 so that that an image capturing direction I of the image sensing device 700 is substantially aligned with or in parallel to the rotational axis R of the rotator 200. Substantially aligned means that the image capturing direction I as shown in FIG. 4 can momentarily diverge from the rotational axis R but on average said image capturing direction is held aligned with or in parallel to the rotational axis R. One reason is that when a load is asymmetrically applied on the rotator 200, e.g. through the tool 300 holding a target object 500, the rotator 200 can swing relative to a vertical axle (not shown in the Figs.) due to the asymmetrical force acting on the tool 300 and hence also on the rotator 200 which means that the rotational axle R will not always be parallel to said vertical axle. The rotator 200 can also swing due to the movement of the crane arm 400. In such an example the image capturing direction I may momentarily not be held aligned with or in parallel to the rotational axis R.

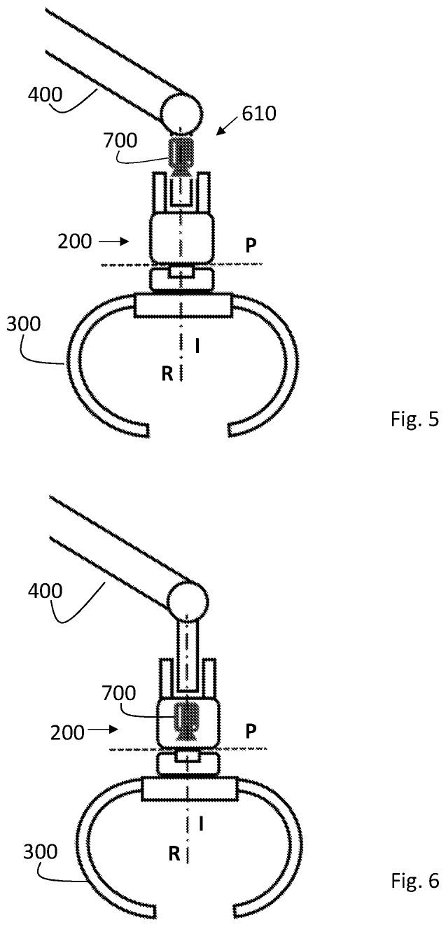

FIG. 5 shows an embodiment of the arrangement 600 when at least one of the image sensing devices 700 is arranged at the rotator 200 but above plan P. The at least one image sensing device 700 is arranged at a link 610 which holds the rotator 200 at the tip of the crane arm 400. The link 610 holding the rotator 200 and the image sensing device 700 can in a non-limiting example be a cardanic suspension. The link 610 can also be a so-called weighing link that can provide information about the weight of a target object 500 held by the tool 300. Since the image sensing device 700 is arranged above plan P the image sensing device 700 will not rotate with the tool 300 but can swing in one plane. An advantage of having the image sensing device 700 above plane P is that the image sensing device 700 is arranged in a protected area far from branches or other obstacles. Generally, the farther from the tool 300 the image sensing device 700 will be more protected against mechanical impact. The image sensing device 700 will also be more protected against water, snow, dirt, etc.

FIG. 6 shows another embodiment of the arrangement 600 when at least one of the image sensing devices 700 is arranged at the rotator 200 above plan P but not in the link 610 as in FIG. 5. Instead the image sensing device 700 is arranged directly at the rotator 200 above plan P. The image sensing device 700 is in this case therefore arranged closer to plan P at the rotator 200. Also, in this case compared to the embodiment shown in FIG. 5, the image sensing device 700 will not rotate with the tool 300 since it is arranged above plan P but can swing in two planes. Also, for the embodiment shown in FIG. 6 the image sensing device 700 is arranged so that that the image capturing direction I of the image sensing device 700 is substantially aligned with or in parallel to the rotational axis R of the rotator 200. The arrangement of the image sensing device 700 shown in FIG. 6 also means good protection for the image sensing device 700.

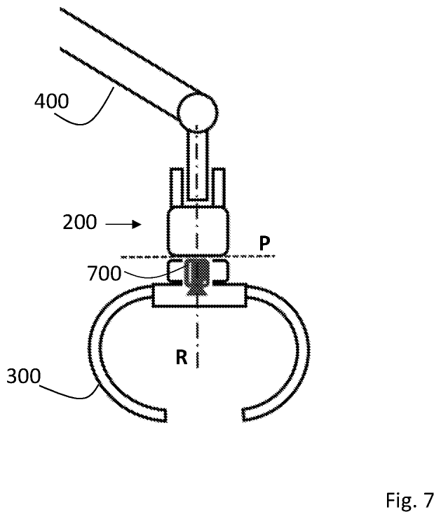

FIG. 7 shows yet another embodiment of the arrangement 600 when at least one of the image sensing devices 700 is arranged at the rotator 200 but below plan P. The image sensing device 700 will therefore in this case rotate with the tool 300. An advantage of having the image sensing device 700 below plane P is that the visual clearance in the direction below the rotator 200. However, instead possible wired communication lines and power supply for the image sensing device 700 have to be arranged through or around the rotator 200. Also, the area below plane P is a rough environment for the image sensing device 700.

It is to be noted that embodiments of the invention relate to all different cases regarding the number and location of the one or more image sensing devices. Hence, the arrangement can comprise one, two, three, and further image sensing devices. The image sensing devices can be arranged at the tip of the crane arm, at the rotator 200 above plan P and/or at the rotator 200 below plan P.

Further, one or more image sensing devices arranged on one or more forest drones, also known as unmanned aerial vehicle, can be used within the scope of the invention. The use of drones has increased rapidly in many different applications, and also in forestry. Image sensing devices arranged on drones can directly or indirectly wirelessly transmit signals to the control device 100, which process such signals to e.g. obtaining the location of the target object as previously described.

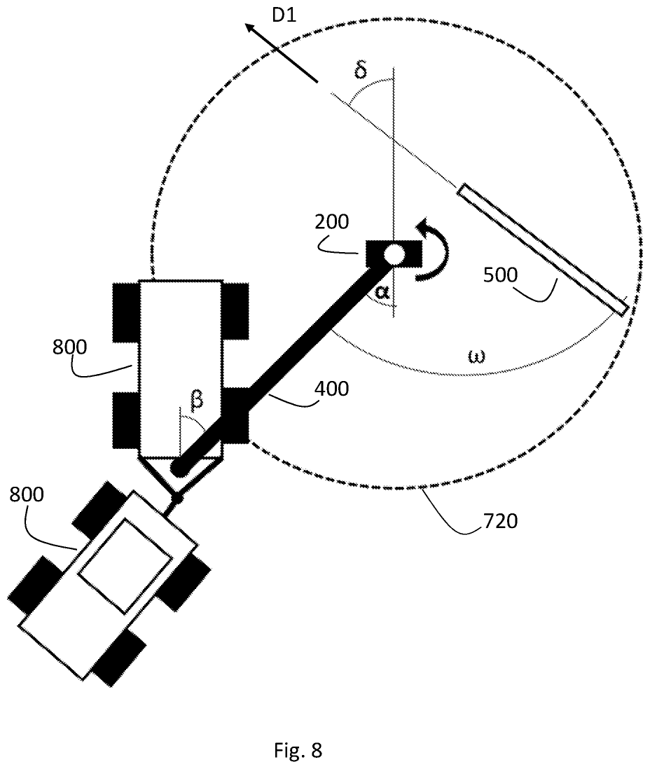

FIGS. 8 to 10 further illustrates different embodiments when an angle δ is considered for controlling the rotator 200 and/or the crane arm 400. The control automation herein comprises to move the crane arm or the crane system so that the rotator 200 and/or the tool 300 gets located above the target object 500. Thereafter, the control automation comprises to align the rotator 200 and/or the crane arm 400 with the target object 500. If the target object 500 has an elongated form and extends in a first direction D1 the rotator 200 and/or the tool 300 is aligned to the first direction D1 so as to e.g. grip a log or a pipe.

Generally, the angle 6 herein defines the angle between the rotator 200 and/or the jib-carried tool 300 and the first direction D1 as shown in FIGS. 8 to 10. The first direction D1 is a main extension direction of the target object 500. Hence, according to embodiments of the invention, the control device 100 is configured to obtain angle 6 defining an angle between the rotator 200 or the jib-carried tool 300 and the first direction D1; and further to control the position between the rotor 202 and the stator 204 of the rotator 200 so that the rotator 200 or the jib-carried tool 300 is aligned with the first direction D1 based on the angle δ. There are two main solutions how the angle δ can be derived depending on whether the image sensing device 700 is arranged above or below plane P.

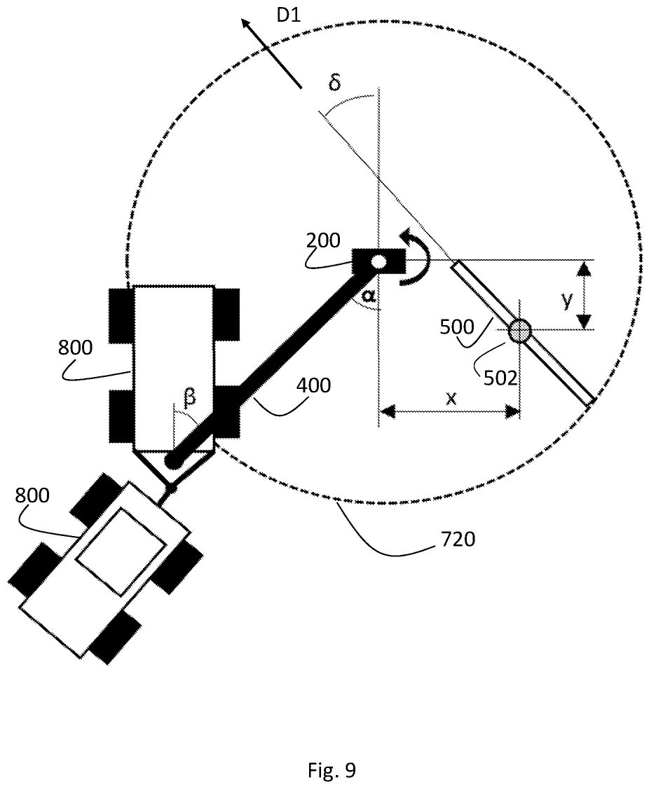

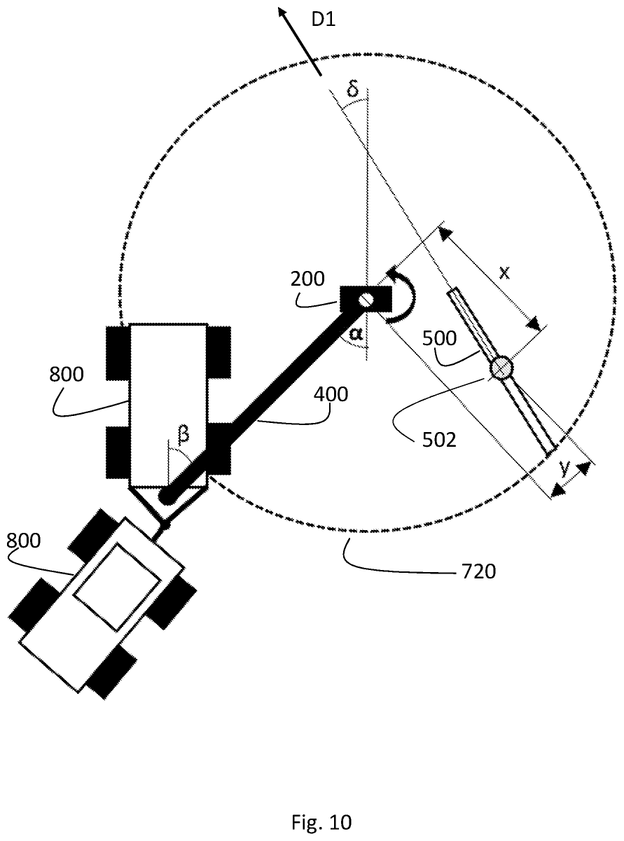

FIG. 8 shows the embodiment of the invention when an image sensing device 700 is arranged at the tip of the crane arm 400. The coverage area of the image sensing device 700 is marked with the dashed circle 720. In this embodiment the control device 100 is configured to obtain angle α defining an angle between the rotator 200 or the jib-carried tool 300 and the crane arm 400; obtain angle ω defining an angle between the crane arm 400 and the first direction D1; and to obtain the angle δ as a difference between the angle α and the angle ω. The relation δ=α−ω for the angles holds for this case. Mentioned angles can be defined as angles for projections of the crane arm 400 or crane system, the rotator 200 and the tool 300 on a horizontal plane representing ground. In the horizontal plane different coordinate systems can be used for defining positions or locations in that horizontal plane. One example is the use of a Cartesian coordinate system with x and y coordinates as illustrated in FIGS. 9 and 10. Another example is the use of a cylindric coordinate system which suits well with the rotational movement of the rotator 200. One additional angle parameter that can be considered is angle β which is shown in FIGS. 8 to 10 and defines the relative angle between a crane arm and the vehicle 800 to which the crane arm is attached. The angle β can be used for controlling the crane arm 400 and/or the rotator 200 if the image sensing device 700 is arranged on the vehicle 800.

As further shown in FIG. 8 the target object 500 is in this example a log on the ground. More generally according to embodiments of the invention the target object 500 has an elongated form substantially extending in a first direction D1 as illustrated with the directional arrow D1 in FIG. 8. Therefore, the control device 100 is further configured to obtain the first direction D1 and to control the position between the rotor 202 and the stator 204 of the rotator 200 so that the rotator 200 or the jib-carried tool 300 is aligned with the first direction D1. Consider the case that a vehicle 800 shown in FIG. 8 is a forwarder and its task is to pick up logs from the ground and to load the logs on the rear wagon of the vehicle 800. The vehicle 800 comprises a crane system comprising crane arms which is moveable relative to the target object 500. The control device 100 is here configured to both control the crane system and the rotator 200.

In an embodiment, controlling the crane arm 400 or the crane system comprises controlling the crane arm 400 or the crane system so that the rotator 200 or the jib-carried tool 300 is moved towards the location of the target object 500. Further, in FIG. 8 angles α and ω are first computed using information about the location of the target object 500. Thereafter angle δ is computed using the relation δ=α−ω. When angle δ has been computed said angle δ is used for aligning the rotator 200 and/or the jib-carried tool 300 with the first direction D1 of the target object 500. Aligning the rotator 200 and/or the jib-carried tool 300 comprises rotate the rotator 200 or the jib-carried tool 300 so that angle δ becomes zero as illustrated in FIGS. 8 to 10 with the rotational black arrow. In one non-limiting example an angle meter that gives the position of rotation between the rotor 202 and the stator 204 as previously described can be used in this respect. In another non-limiting example, a current angle δ can be continuously be computed so that the rotator 200 or the jib-carried tool 300 is rotated until the current angle δ is zero. The current angle δ can be computed from images continuously provided by the image sensing device 700.

According to further embodiments, controlling the crane arm 400 or the crane system comprises controlling the crane arm 400 or the crane system so that the rotator 200 and/or the jib-carried tool 300 is located above the target object 500 as shown in FIG. 8. This is important for picking up the target object 500 from the ground in automatic or semi-automatic applications of the invention.

The embodiment illustrated in FIG. 8 relates to when the target objects are logs which have asymmetric mass distribution. For such target objects the mass centre of the target object 500 has to be obtained. When the mass centre has been obtained the crane arm 400 can be controlled so that the rotator 200 or the jib-carried tool 300 is substantially located above the mass centre of the target object 500. In that location the jib-carried tool 300 can act on the target object, e.g. gripping a log.

However, as previously mentioned for cases when the target object 500 has an elongated form and symmetric mass distribution an alternative method can be used. According to these embodiments the middle point of the target object 500 is obtained instead of the mass centre. Thereafter, the crane arm 400 or the crane system is controlled so that the rotator 200 or the jib-carried tool 300 is substantially located above the middle point of the target object 500.

Moreover, according to further embodiments of the invention, additional information except the location of the target object can be used for controlling the rotator 200 and/or the crane arm 400. In one such embodiment position data for the target object 500 is obtained. Said position data is also used for controlling the rotator 200 and/or the crane arm 400 based on the position data. The position data could be used with GPS techniques or the like techniques. In an example a tree harvester can mark the position of each log and this position information is latter used by the control device 100 for controlling the crane arm 400 and/or the rotator 200. An advantage is that the target object 500 can easily be found. This is especially the case if the target object 500 is hidden, e.g. when a log is covered by snow.

In another such embodiment also the location of the rotator 200 is used for controlling the rotator 200. This is especially advantage when the rotator is moving relative to the location of the target object. For example, when the vehicle, such as harvester and forwarder, to which the rotator 200 is attached, is moving relative to the target object. Hence, the controlling of the rotator 200 can continuously be updated due to change of location of the rotator. One such example relates to the case when the rotator and/or the tool is to be aligned with the first direction D1 of the target object.

FIG. 9 shows an embodiment of the invention when an image sensing device 700 is arranged at the rotator 200 above plane P. It is also shown in FIG. 9 how the rotator 200 and/or the tool 300 is aligned to the first direction D1 by using angle δ. The mass centre 502 of the log 500 is also shown.

FIG. 10 shows an embodiment of the invention when an image sensing device 700 is arranged below plane P. It is also shown in FIG. 10 how the rotator 200 and/or the tool 300 is aligned to the first direction D1 by using angle δ. In this case the angle δ can be directly derived as shown in FIG. 10. Hence, angles α and ω do not have to be derived which means less computations and therefore simplified implementation. The mass centre 502 of the log 500 is also shown.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the control device 100 comprises the necessary communication capabilities in the form of e.g., functions, means, units, elements, etc., for performing the solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the solution.

Especially, the processor(s) of the control device 100 may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. An arrangement for controlling a rotator, the arrangement comprising a control device;
a rotator for a jib-carried tool; and
one or more image sensing devices;
wherein the control device is configured to obtain one or more signals from the one or more image sensing devices, obtain a location of a target object based on the one or more signals, and control the rotator based on the location of the target object.

2. The arrangement according to claim 1, wherein the control device is configured to
obtain a position of rotation between a rotor and a stator of the rotator, and
control the rotator based on the location of the target object and the position of rotation between the rotor and the stator.

3. The arrangement according to claim 2, wherein the control device is configured to
obtain the position of rotation between the rotor and the stator of the rotator from an angle meter arranged at the rotator.

4. The arrangement according to claim 2, wherein controlling the rotator comprises
control the position between the rotor and the stator of the rotator in relation to the target object.

5. The arrangement according to claim 4, wherein controlling the rotator comprises control a speed of change of the position between the rotor and the stator of the rotator.

6. The arrangement according to claim 2, wherein the target object has an elongated form substantially extending in a first direction, and wherein the control device is configured to
obtain the first direction based on the one or more signals,
control the position between the rotor and the stator of the rotator so that the rotator and/or the jib-carried tool is aligned with the first direction.

7. The arrangement according to claim 6, wherein the control device is configured to
obtain an angle d defining the angle between the rotator or the jib-carried tool and the first direction,
control the position between the rotor and the stator of the rotator so that the rotator and/or the jib-carried tool is aligned with the first direction based on the angle d.

8. The arrangement according to claim 7, wherein obtaining the angle d comprises obtain an angle a defining the angle between the rotator or the jib-carried tool and a crane arm to which the rotator is attached,
obtain an angle w defining the angle between the crane arm and the first direction, and
obtain the angle d as a difference between the angle a and the angle w.

9. The arrangement according to claim 1, wherein the arrangement further comprises a crane arm to which the rotator is attached, and wherein the control device is configured to
control the crane arm based on the location of the target object.

10. The arrangement according to claim 9, wherein controlling the crane arm comprises
control the crane arm so that the rotator or the jib-carried tool is moving towards the location of the target object.

11. The arrangement according to claim 9, wherein controlling the crane arm comprises
control the crane arm so that the rotator and/or the jib-carried tool is located above the target object.

12. The arrangement according to claim 11, wherein the control device is configured to
obtain a middle point of the target object, and
control the crane arm so that the rotator and/or the jib-carried tool is substantially located above the middle point of the target object.

13. The arrangement according to claim 9, wherein the control device is configured to
obtain a location of a mass center of the target object, and
control the crane arm so that the rotator and/or the jib-carried tool is located above the mass center of the target object.

14. The arrangement according to claim 9, wherein the control device is configured to
obtain position data for the target object, and
control the rotator and/or the crane arm based on the position data.

15. The arrangement according to claim 1, wherein the control device is configured to
obtain a location of the rotator, and
control the rotator based on the location of the target object and location of the rotator.

16. The arrangement according to claim 1, wherein at least one of the one or more image sensing devices is arranged at a tip of a crane arm adjacent to the rotator.

17. The arrangement according to claim 1, wherein at least one of the one or more image sensing devices is arranged at the rotator above a plane perpendicular to the rotational axis of the rotator and in which the rotor and the stator are arranged to move relative to each other.

18. The arrangement according to claim 1, wherein at least one of the one or more image sensing devices is arranged at the rotator below a plane perpendicular to the rotational axis of the rotator and in which the rotor and the stator are arranged to move relative to each other.

19. The arrangement according to claim 16, wherein an image capturing direction of at least one of the one or more image sensing devices is substantially aligned with or in parallel to the rotational axis of the rotator.

20. The arrangement according to claim 19, wherein the image capturing direction is in a direction from the rotator towards the jib-carried tool.

21. A method for controlling a rotator, the method comprises
obtaining one or more signals from one or more image sensing devices, obtaining a location of a target object based on the one or more signals, and
controlling the rotator based on the location of the target object.

22. A computer program with a program code for performing a method according to claim 20 when the computer program runs on a computer.
